(19) United States
(12) Patent Application Publication
(10) Pub. No.: US 2003/0056036 A1
(43) Pub. Date: Mar. 20, 2003

(54) Apparatus and method for testing universal serial bus communication

(76) Inventor: Gary Don Carlton, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/952,999

(22) Filed: Sep. 14, 2001

(51) Int. Cl. G06F 3/00

(52) U.S. Cl. 710/15

(57) ABSTRACT

A USB test device is disclosed comprising an input/output (I/O) subsystem to capture communication between a host and a peripheral device communicating via at least on USB cable. A processor subsystem analyzes the captured communication and determines if a communication failure occurred and if the host or peripheral device caused the communication failure. The tester can also be part of a computer system that comprises at least one universal serial bus (USB), a host computer and a peripheral device. The host computer and the peripheral device communicate over the at least one USB. A test device is connected to the at least one USB to capture USB communications between the host computer and the peripheral device. The test device analyzes a captured communication, determines if a USB communication failure occurred, and determines whether the host computer or the peripheral device caused the USB communication failure. A method for testing communications over a USB is also disclosed. USB communications between a host and a USB peripheral device are captured without interfering with the communications. The captured communication is analyzed to determine if a USB communication failure occurred and whether the host or peripheral device caused the communication failure.

### BACKGROUND OF THE INVENTION

1. Field of the Invention

This invention relates to Universal Serial Buses and more particularly to an apparatus and method for testing a Universal Serial Bus device's communication.

2. Description of the Related Art

In the past, connecting peripheral devices to a home or office computer was relatively complex. Printers needed high-speed data transfer and were connected to the computer's parallel printer port; most computers only had one such port. Devices such as modems and digital cameras used the computer's serial ports. Most computers had only two serial ports and in many cases their data transfer was too slow. Other devices that needed a high-speed connection, such as zip drives, also used parallel ports and came with their own connection cards that needed to be installed in the computer. However, the number of card slots in a computer was limited and card installation could be a complex process.

To address these problems, most computers for the home or office now come with one or more Universal Serial Bus (USB) connectors which allow for quick and easy attachment of peripheral devices such as mice, printers, scanners, Webcams, joysticks, etc. The USB provides a standardized bus for connecting up to 127 devices to a computer (directly or through a hub), with each device consuming up to 6 megabits per second, which is fast enough for most peripheral devices.

The operating system of most computers now supports a USB, so installation of devices on a USB is also quick and easy. Peripheral USB devices are connected to most computers at one of the USB connectors at the back of the computer. If the device is new to the computer, the computer's operating system auto-detects it and asks for the driver disk associated with the peripheral device (also referred to as “client software”). If the software from the driver disk has already been installed, the computer activates it and starts communicating with the peripheral device.

When the host computer powers-up, it queries all of the USB devices connected to the bus and assigns each one an address, a process called “enumeration”. Devices are also enumerated when they are connected to the bus when the computer is running. The host also finds out from each device what type of data transfers it performs. Interrupt data transfers are performed by devices that send very little data, such as a mouse or keyboard. Bulk data transfers are conducted in transfers of large data packets and used for devices like printers. Isochronous transfers are used for devices such as speakers that use streams of data between the host and the device. The host computer can also send command or query parameters with “control packets”.

All bus transactions involve transmitting up to three packets, and a transaction begins when the host controller sends a token package that includes the transaction's type and direction, a device address, and an endpoint number. The addressed device decodes its address from the packet and a data transfer takes place between the host computer and the device in the direction specified by the token packet. The transaction source then either sends a data packet or indicates that it has no data to transfer. The destination responds with a handshake packet to indicate whether the transaction was successful.

USB connection and communication problems can occur, with some of the more common problems being: the USB port is disabled during the host computer PC BIOS setup, the PC cannot detect the USB components, or there is a conflict at the USB port. Many of these problems can be addressed from the host computer. For instance, to determine whether the USB port is disabled, the PC BIOS (or setup screen) can be accessed at the computer terminal and, if it is disabled, the port setting can be changed to Enabled. If there is a conflict at the USB port, the device manager can be accessed at the computer terminal and under the USB icon a conflict symbol can appear next to the conflicting devices. The type of symbol at each component is then recorded and additional steps are taken to remedy the conflict.

There are times when the host computer cannot communicate with one of the USB devices and none of the standard correction procedures corrects the problem. In these instances there is no easy way to determine whether there is a problem with the host computer or the USB device. Currently, the only way to determine which of the two is not functioning properly is to attach a logic analyzer to the bus that captures the communication stream between the host computer and the USB device. Typical logic analyzers that are used for this purpose include the “USB Detective” and “USB Inspector” from Computer Access Technologies Corporation (CATC). However, these devices are expensive, bulky and complicated to operate. The captured communication stream is either displayed on the test device or printed out. The stream is then manually analyzed lineby-line by a user to detect when the communication broke down and what was the cause. This can be a complicated process and usually requires expertise in USB data transfer protocol.

### SUMMARY OF THE INVENTION

The present invention provides a compact, inexpensive and easy-to-use USB test device and associated test procedure.

A preferred USB test device comprises an input/output (I/O) subsystem to capture communication between a host and a peripheral device communicating via at least on USB cable and a processor subsystem to analyze the captured communication and determine if a communication failure occurred and if the host or peripheral device caused the communication failure.

A preferred computer system utilizing the new tester comprises at least one universal serial bus (USB), a host computer and a peripheral device, with the host computer and the peripheral device communicating over the at least one USB. A test device is connected to the at least one USB to capture USB communications between the host computer and the peripheral device. The test device analyzes a captured communication, determines if a USB communication failure occurred, and determines whether the host computer or the peripheral device caused the USB communication failure.

A method for testing communications over a USB is also disclosed. USB communications between a host and a USB peripheral device are captured without interfering with the communications. The captured communication is analyzed to determine if a USB communication failure occurred and whether the host or peripheral device caused the communication failure.

These and other further features and advantages of the invention will be apparent to those skilled in the art from the following detailed description, taken together with the accompanying drawings, in which:

### BRIEF DESCRIPTION OF THE DRAWINGS

FIG. 1 is a diagram of one embodiment of a USB tester according to the present invention, connected in a computer system between the host computer and a peripheral USB device;

FIG. 2 is a perspective view of a prior art USB cable showing its internal wires;

FIG. 3 is a more detailed block diagram of the system in FIG. 1;

FIG. 4 shows a flowchart of a method according to the present invention for testing USB communications;

FIG. 5 shows a flowchart of a connection test device Get Descriptor request according to the present invention; and

FIG. 6 shows a flowchart of a connection test device Set Descriptor request according to the present invention.

### DETAILED DESCRIPTION OF THE INVENTION

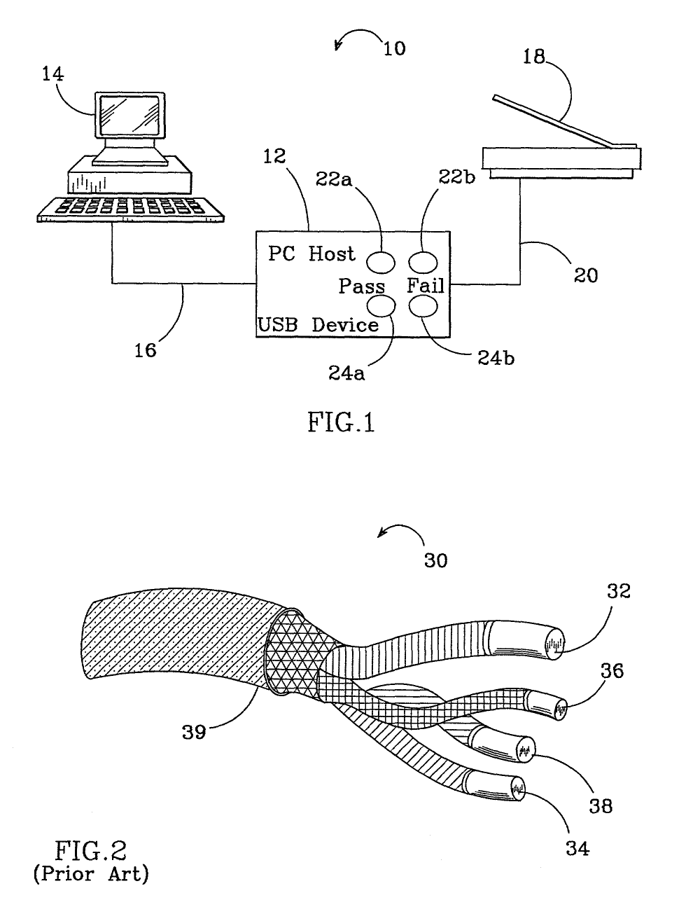

FIG. 1 shows a computer system 10 with one embodiment of connection test device 12 connected in accordance with the present invention. The tester 12 is connected to a USB host 14 by a Universal Serial Bus (USB) cable 16, with one end of the cable connected to the tester 12 and the other end plugged into one of the host's USB ports. The connection test device 12 can be used with many different hosts, with a preferred host 14 being an office or home personal computer (PC). The host/computer 14 controls most of the USB communication over the USB bus.

FIG. 2 shows a typical USB cable 30, which contains four wires, two that carry the USB communication signals and two that carry power. The red wire 32 typically carries +5 volts and the brown wire 34 is ground. The host computer 14 typically supplies up to 500 milliamps of power on the red wire 32 at 5 volts so that low power USB devices can draw their power directly from the cable 30. High power USB devices have their own power supplies and draw minimal power from the USB bus. The bus also includes a twisted pair of yellow and blue wires 36 and 38 that carries the USB communication packets. The packet are transmitted in differential signals having 0.3 volts for logic low and above 2.8 volts for logic high. The clock is combined with the data stream using nonreturn-to-zero-invert (NRZI) encoding. The typical cable has a shield 39 to protect the internal wires from external interference.

USB cables 30 can communicate with PC 14 through a host controller that can be implemented through combinations of hardware, firmware and software. USB devices are hot-swappable on the USB cable 30, meaning they can be plugged into the cable 30 and unplugged at any time. Also, many USB devices can be put to sleep by the host computer when the computer enters a power saving mode.

Referring again to FIG. 1, one end of the USB cable 16 can be integral to the tester 12 with the other end connectable to the USB port on the host computer 14. Alternatively, the cable 16 can be separate and connectable to both the tester 12 and the computer 14. To avoid confusion, a standard USB cable uses “A” and “B” connectors that mate with different sockets. The “A” connector at one end connects to devices upstream toward the host computer and the “B” connector at the other end connects downstream from the host computer. In the system 10 with a separate cable 16, the device 12 has a “B” socket for connecting the cable's “B” connector and the computer 14 has an “A” socket for attaching to the other end of the cable 16 having the “A” connector.

The tester 12 also connects to a USB device 18 through a USB cable 20. Although the USB device 18 shown in FIG. 1 is a scanner, different USB devices can be used including, but not limited to, printers, mice, joysticks, flight yokes, digital cameras, webcams, data acquisition devices, modems, speakers, telephones, video phones, storage devices and network connections. Also, more than one USB device 18 can be connected to and communicating over the USB cable 20. Also, the system 10 can have more than one USB bus with a tester device 12 capturing and testing communication over the bus. If the USB cable 20 is separate, the tester 12 has an “A” socket that connects to the cable's “A” connector and the USB device 18 has a “B” socket for the “B” connector.

In operation, the tester 12 captures the communication between the computer 14 and the USB device 18 and preferably provides a pass or fail indication for both. The tester 12 is a “pass through” device that is invisible to the computer 14 and the USB device 18, allowing the communication between the host computer 14 and USB device 18 to occur without interference. The tester 12 may be powered by the +5 volt supply on the USB cable.

Many different pass/fail indicators can be used, with the preferred indicators being green and red light emitting diodes (LEDS) 22a and 22b for the host computer's pass and fail indication, respectively. Green and red LEDS 24a and 24b are similarly used for the peripheral device's pass and fail indication. The LEDs are mounted integrally to the tester 12 so that they are connected to the tester's internal circuitry and easily viewed from outside the tester 12.

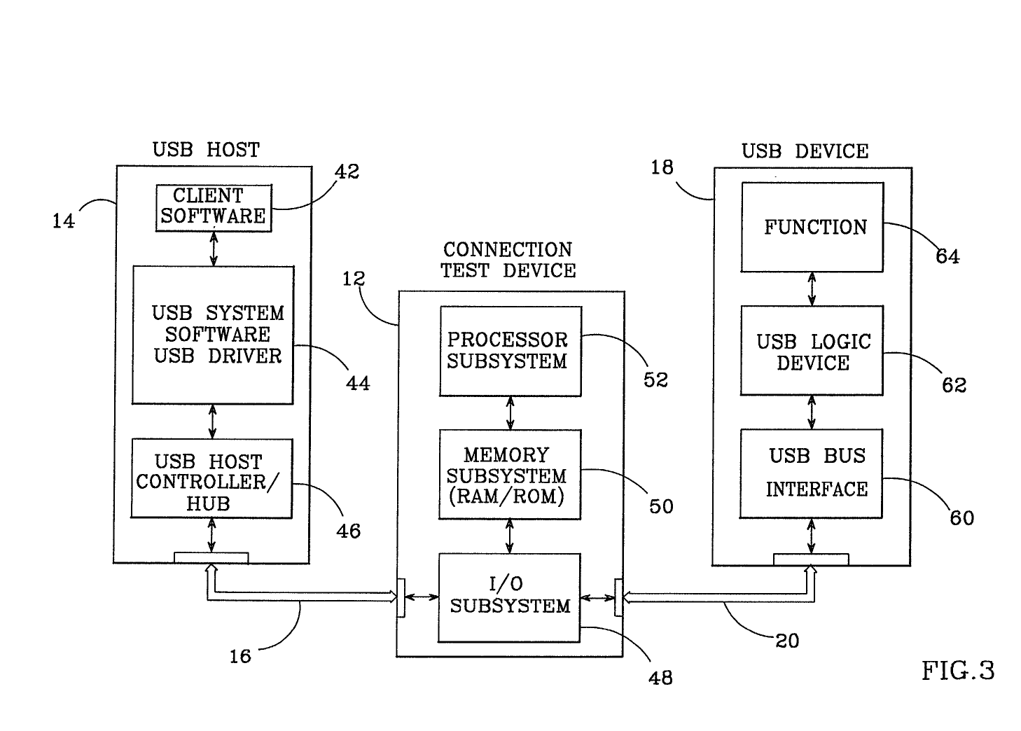

FIG. 3 shows more detail of the computer system 10 shown in FIG. 1. The computer 14 includes the client software 42 that is provided with the USB device 18 and is stored in memory within the computer 14. Client software works in connection with the test device 12 and the USB device 18. When the USB device 18 is newly connected to the USB, the host computer 14 auto-detects it and asks for installation of the client software. If the client software 42 has already been installed, the computer 14 activates it and starts communicating with the USB device 18.

The host computer 14 also includes USB system software and USB driver 44, which controls communication over the USB. This software is commercially available and is often included as part of the computer's operating system software. Examples of recent operating systems that include this software are Microsoft® Windows® XP/Windows 2000 and Windows Millennium Edition/Windows 98. The driver 44 communicates with the client software 34 and the USB host controller/hub 46 to control the USB communications.

The USB host controller 46 is also commercially available and provides the computer's hardware connection to the USB bus. It commonly has 2 USB ports. As mentioned above, using USB hubs the USB Host Controller 46 can support up to 127 USB devices in a tree structure. The Controller 46 can be supplied as a separate hardware assembly, or as is more often the case, it is integrated on the host computer's motherboard chipset. Older computers that are not equipped with a Controller 46 can be upgraded by installing controller PCI cards. The preferred USB Host Controller 46 is compatible with either the Open Host Controller Interface (OHCI by Compaq, Microsoft and National Semiconductor) or the Universal Host Controller Interface (UHCI by Intel) standard. Both types of controllers have the same capabilities and USB devices will function regardless of which standard the controller 46 supports.

The tester 12 comprises an input/output (I/O) subsystem 48, a memory subsystem 50, and a processor subsystem 52, all of which can be included on an application specific integrated circuit (ASIC) or formed from discrete off-the-shelf components. A tester 12 of discrete components is generally larger and can require more involved software programming. A tester comprised of an ASIC tends to result in a smaller tester that consumes less power. The I/O subsystem 48 is similar to the USB host controller/hub 46 and provides the tester's hardware connection to the USBs 16 and 20. The tester 12 gets its power from the USB so it connects to the USB's power wires 32, 34 and its twisted pair communication wires 36, 38. The preferred I/O subsystem 48 has a “A” socket for the USB cable 20 running to the USB device 18 and it has a “B” socket for the cable 16 from the computer 14.

The I/O subsystem 48 captures the communication between the computer 14 and the USB device 18 and stores the communications in the tester's memory subsystem 50. The memory subsystem preferably has both random access memory (RAM) and read-only memory (ROM). The ROM stores the software for running the processor subsystem 52 and any software necessary for the I/O subsystem 48. This software is preferably loaded into the ROM before the tester 12 is delivered and the ROM retains the software even if power is removed. The processor subsystem 52 communicates with the ROM and reads the software instructions necessary to perform its functions.

The RAM is used by the I/O subsystem 48 for storing captured communications between the computer 14 and the USB device 18. The processor subsystem 52 can then read the captured communication from RAM and analyze it to determine whether a communication error occurred. The processor subsystem 52 then generates the necessary commands to respond. In one response the processor subsystem 52 stores a pass/fail message in RAM, the I/O subsystem 48 reads the pass/fail message and sends it in a packet to the host computer 14. As discussed below, the I/O subsystem 48 can also send other commands to the host computer 14 or the USB devices.

One example of this process (more fully described below) is the Get Descriptor command from the host computer 14 and the corresponding descriptor response from the USB device 18. If the return descriptor is not valid, the tester 12, under control of the processor subsystem 52, preferably returns a status message to the host computer 14 telling it to set the USB device's descriptor or to update its non-volatile RAM (NVRAM). The processor subsystem 42 also illuminates the appropriate fail LED on the tester 12.

The processor subsystem 52 can be any commercially available microprocessor having the capabilities to read instruction from ROM, analyze the captured commands from RAM, generate the necessary response, and store the response in RAM. Suitable processors include but are not limited to processor SA-110 from Intel Corporation and MC68060 Motorola.

The pass/fail LEDs 22a-b and 24a-b preferably remain illuminated until the next USB communication packet is analyzed. Alternatively, the LEDs can be cleared at predetermined time after each packet is analyzed. The tester 12 can also have a hardware clear button that clears the LEDS when activated by a user, or alternatively the LEDs could be cleared by a host computer 14 message.

The USB device 18 has a USB bus interface 60 that is similar to the I/O subsystem 48 and provides USB device's hardware connection and interface to the USB 20. The interface 60 has a “B” socket that connects to the “B” connector on the bus 20.

The USB logic device 62 provides the USB device's intelligence so that it can communicate with the USB bus interface 60. It contains the firmware or software necessary to respond to commands from the host computer 14, including returning a descriptor in response to the computer's Get Descriptor command. USB logic device 62 comprises firmware/software to enable the USB device 16 to accept initialization of its NVRAM. Each USB device 18 also preferably has a function block 64 that is in communication with the USB logic device 62. Function block 64 comprises the logic for the function of the USB device, such as scanner, camera, printer, etc.

Testing Method

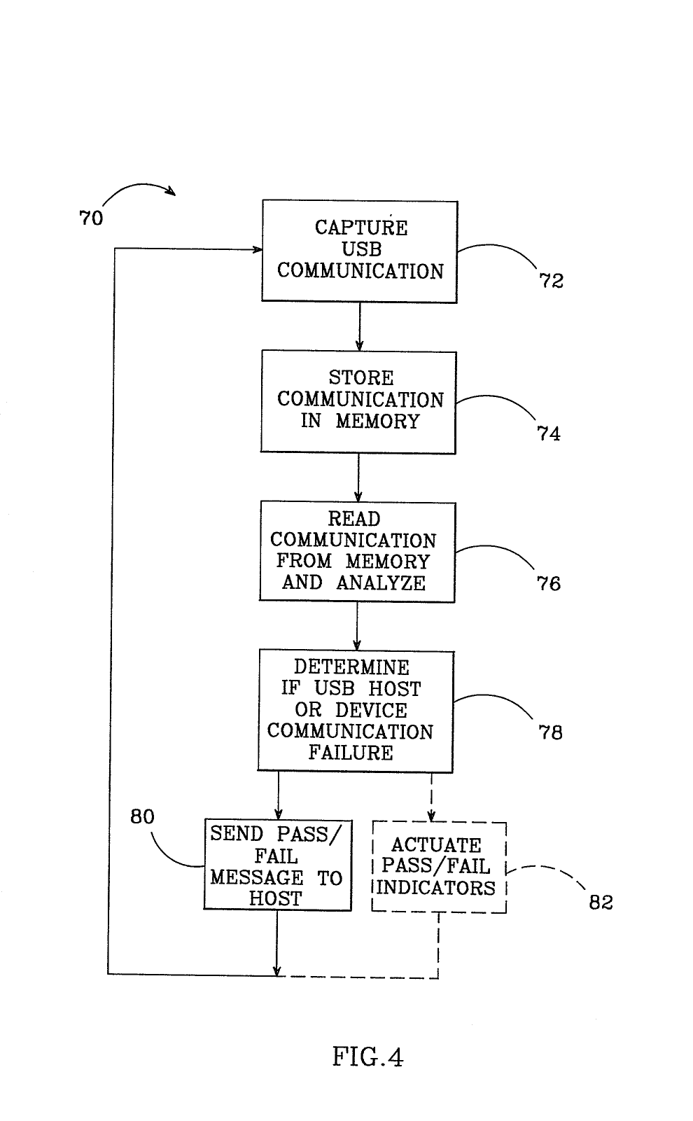

FIG. 4 shows a flow diagram 70 for a testing method in accordance with the present invention. The method 70 can be performed by the tester 12 and begins at initial step 72 of capturing USB communications. In step 74 the communications are stored in memory, and in step 76 the communications are read from memory and analyzed. In step 78 a determination is made whether the USB host 14 or USB device 18 experienced a communication failure. In step 80, a pass/fail message is preferably generated and corresponding to each of USB host 14 and USB device 18, and the messages are sent to the USB host 14. In alternative step 82, pass/fail indicators for the USB host and device are directly activated. When the process is complete the next USB communication can be captured for analysis.

As described above, the pass or fail determination can be made by comparing functioning USB communications to captured USB communications. Also, the determination can be also be made by timing the response to certain requests to determine whether the response is made within a specified time.

Get Descriptor Request

The method 70 and the tester 12 can be used to analyze standard host computer requests and the USB device 18 responses. Some of the functions that are performed by these requests include configuring a USB device 18, controlling the state of the device's USB interface 60, and controlling data transfer. One of the more common computer commands (also referred to as requests) is the Get Descriptor from the USB device 118, which permits the computer 14 to request any USB device's descriptors using the device's address from initial configuration.

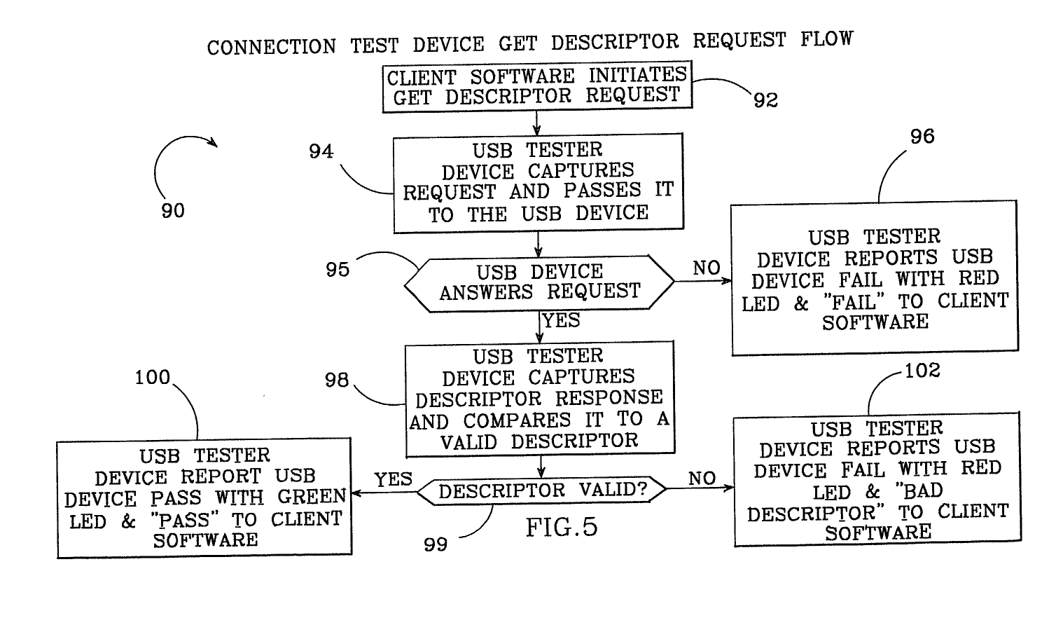

FIG. 5 shows a flow diagram 90 for a Get Descriptor request from the host computer 14, according to the present invention, to test the request and response. In step 92 the host computer's client software 42 and USB system software 44 initiate a Get Descriptor request that is the sent to the USB host controller 46 and on to the USB 16.

In step 94, the I/O subsystem 48 in the tester 12 captures the Get Descriptor command and passes it on to the USB device 18 in the same form. The command is then stored in the RAM within the tester's memory subsystem 50 where it is read by the processor subsystem 52.

In step 95, the tester 12 waits for the USB device 18 to respond to the Get Descriptor command. In step 96, if there is no USB device response the tester 12 reports a USB device fail by illuminating its corresponding USB device fail LED 24b and sending a “fail” message to the computer's client software 42. This is all done under the control of the tester's processor subsystem 52 that waits a predetermined amount of time for the USB device's response and, when the time elapses, takes the above actions. The processor subsystem 52 can load the “fail” message into the memory subsystem's RAM 50. The message is read by the I/O subsystem 48 and sent to the computer 14.

In step 98, if the USB device 18 responds to the Get Descriptor request by sending its descriptor within the specified time, the tester's I/O subsystem 48 captures the response and stores it in the memory subsystem's RAM. It is then read by the processor subsystem 52 and compared to a valid descriptor to determine whether there was a USB device communication failure. In one embodiment, valid descriptors are stored in the memory subsystem 50 and read by processor subsystem 52 for comparison to the captured descriptor.

In step 99, the processor subsystem 52 determines whether the captured Descriptor is valid. In step 100, if the descriptor is valid the processor subsystem 52 illuminates its USB device pass LED 24a and sends a USB device pass message to the host computer 14. In step 102, if the USB descriptor is not valid the processor subsystem 52 illuminates USB fail LED 24b and generates a “bad” descriptor message. The message is stored in the memory subsystem 50 and the I/O subsystem 48 reads the message and sends it to the host computer 14.

Set Descriptor

When a “bad” descriptor message is returned to the host computer 14 in response to a Get Descriptor request, the USB device's failure to provide the proper descriptor can be caused by the USB device having a corrupted NVRAM. When the computer 14 enumerates the USB devices on the USB, each of the USB devices has a unique identifier that is often stored in USB device's NVRAM. Other information can be kept in the NVRAM such as the burn-in date, dates of repair and scan counts. Corrupted or non-initialized NVRAM prevents a USB device 18 from being enumerated into the bus and communicating with the computer 14, and can also result in providing a bad descriptor.

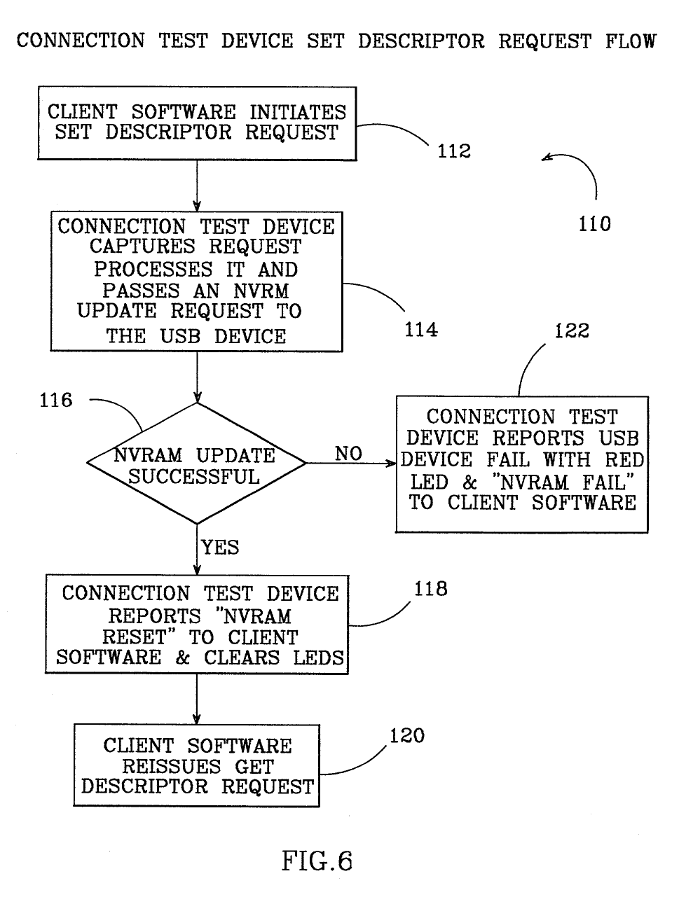

FIG. 6 shows a flow diagram 110 for a Set Descriptor request from the computer 14, according to the present invention, to test the request and response. In step 112, the computer's client software 42 issues a Set Descriptor request in response to a “bad” descriptor message from the tester 12 (as described above). The USB host controller sends the Set Descriptor request on the USB 16. In step 114, the request is captured by the tester's I/O subsystem 48. The request is processed by the processor subsystem 52 and a NVRAM update message is send by the tester's I/O subsystem 48 to the appropriate USB device 18 via USB 20.

In step 116, the tester I/O subsystem 48 waits for a response from the USB device 18. In step 118, if the response indicates a successful NVRAM update, the tester 12 preferably reports “NVRAM” reset to the host computer's client software 42 and clears any illuminated LEDS. In step 120 the client software 42 then issues a Get Descriptor request and a flow diagram such as that illustrated in FIG. 5 is followed.

In step 122, if the NVRAM update is not successful, the tester 12 preferably reports a USB device fail by illuminating the USB device fail LED 24b and sending an “NVRAM Fail” message to the computer's client software 42. As above, the appropriate messages are generated by the tester's processor subsystem 52 and sent by the tester's I/O subsystem 48.

Although the present invention has been described in considerable detail with reference to certain preferred configurations thereof, other versions are possible. The tester 12 can have different subsystems that perform the same function as its I/O subsystem 48, memory subsystem 50 and processor subsystem 52. Also, the tester 12 can be used to analyze many different USB communication packets beyond those described above. The method 70 can include different steps in accordance with the present invention.

I claim:

1. A computer system, comprising:
at least one universal serial bus (USB);
a host computer;
a peripheral device, said host computer and said peripheral device communicating over said at least one USB; and
a test device connected to said at least one USB to capture USB communications between said host computer and said peripheral device, said test device analyzing a captured communication, determining if a USB communication failure occurred, and determining whether said host computer or said peripheral device caused the USB communication failure.

2. The computer system of claim 1, wherein said test device captures the communication without interfering with it.

3. The computer system of claim 1, wherein said test device comprises a processor subsystem to perform the analysis of the captured communication, and determinations based on the results of said analysis.

4. The computer system of claim 1, wherein said test device, as part of analyzing a captured communication, compares the captured USB communication to functioning USB protocol to determine if a USB communication failure occurred and whether said host or said peripheral device caused the USB communication failure.

5. The computer system of claim 1, wherein said test device determines whether said host or said peripheral device experienced a USB communication failure by tracking whether a communication response was made within a specified time.

6. The computer system of claim 1, wherein said test device generates a pass or fail indication for whichever of said host computer or said peripheral device has experienced a USB communication failure.

7. The computer system of claim 6, wherein said test device includes LED pass and fail indicators for said host computer and said peripheral devices, respectively.

8. The computer system of claim 1, wherein said test device comprises:
an input/output (I/O) subsystem to capture communications over said USB; and
a memory subsystem, said I/O subsystem storing a captured communication in said memory subsystem.

9. The computer system of claim 1, further comprising at least one additional said peripheral device and corresponding said at least one additional test device to determining if a USB communication failure occurred between said host and said at least one additional peripheral device.

10. A Universal Serial Bus (USB) communication tester, comprising:
an input/output (I/O) subsystem to capture communication between a host and a peripheral device communicating via at least one USB cable; and
a processor subsystem to analyze said captured communication and determine if a USB communication failure occurred and if the host or peripheral device caused the USB communication failure.

11. The USB tester of claim 10, wherein said at least one USB cable comprises a first USB cable to connect said I/O subsystem to a USB host and a second USB cable to connect said I/O subsystem to a USB peripheral device, the host and peripheral device communicating over said first and second USB cables.

12. The USB tester of claim 10, wherein said I/O subsystem captures the communication without interfering with the communication flow.

13. The USB tester of claim 10, further comprising a memory subsystem that stores functioning USB communications and said captured communication.

14. The USB tester of claim 13, wherein said processor subsystem analyzes said captured communication by comparing it to the stored functioning USB communication.

15. The USB tester of claim 10, wherein said processor subsystem tracks the time for USB communication response by the host or peripheral device.

16. The USB tester of claim 10, wherein said processor subsystem generates a pass or fail indication for whichever of the host or peripheral device experienced a communication failure.

17. The USB tester of claim 10, further comprising pass and fail indicators for the host and peripheral device respectively to indicate whether the host and peripheral device are properly communicating.

18. The USB tester of claim 10, wherein said processor subsystem generates a fail indication and message if said peripheral device does not respond to a Get Descriptor said request.

19. The USB tester of claim 10, wherein said processor subsystem generates a fail indication and message if said peripheral device responds to a Get Descriptor request from said host with a bad descriptor response.

20. The USB tester of claim 10, wherein said processor subsystem generates pass indication and message if said peripheral device responds to a Get Descriptor request with a good descriptor.

21. The USB tester of claim 10, wherein said processor subsystem generates a non-volatile random access memory (NVRAM) update request in response to a Set Descriptor Request from the host, said I/O subsystem sends said NVRAM update request to the peripheral device, and said processor subsystem indicates either a fail or pass and generates a fail or pass message depending on said peripheral device response to said update request.

22. A method for testing communications over a Universal Serial Bus (USB), comprising:
capturing USB communications between a host and a USB peripheral device without interfering with said communications; and
analyzing a captured communication to determine if a USB communication failure occurred and whether the host or peripheral device caused the communication failure.

23. The method of claim 22, further comprising generating a pass or fail indication for said host or USB device depending upon whether either experienced a failure during said communication.

24. The method of claim 22, wherein said pass or fail indication is generated by comparing a captured USB communication to a stored functioning USB communication.

25. The method of claim 22, wherein said pass or fail indication is generated by determining if a USB communication was made within a specified time.

26. The method of claim 22, further comprising the step of sending a communication pass or fail message to the USB host based upon said analysis of a captured communication.
